(19) United States
(12) Patent Application Publication
(10) Pub. No.: US 2010/0192431 A1
(43) Pub. Date: Aug. 5, 2010

(54) Motorcycle Registration Display

(76) Inventor: Edward J. Woznica, JR., Anza, CA (US)

Correspondence Address: CROCKETT & CROCKETT, P.C., 26020 ACERO, SUITE 200, MISSION VIEJO, CA, 92691, US

(21) Appl. No.: 12/363,531

(22) Filed: Jan. 30, 2009

(51) Int. Cl. B60R 13/10

(52) U.S. Cl. 40/209

(57) ABSTRACT

A registration sticker display apparatus may be formed of a resilient tube having a longitudinal slot to enable the tube to be removably clipped onto the front fork tube of a motorcycle. A registration sticker may be attached to the outer surface of the sticker display tube. Any service or replacement necessary for the front fork tube may be accomplished by removing the sticker display tube without damaging or destroying the registration sticker.

### FIELD OF TH INVENTIONS

The inventions described below relate to the field of motorcycle accessories and more specifically to the field of motorcycle registration display apparatus.

### BACKGROUND OF THE INVENTION

Motorcycles like all other motorized vehicles are required to have a registration tag or sticker displayed when the vehicle is operated on public highways and public land. Motorcycle registration stickers are often required to be attached in an easily visible location for authorities to verify the registration status of a vehicle from a distance. For most motorcycles, particularly those used in rough or offroad terrain, the registration attachment location is typically on one arm of the front fork. As the front fork arms are hydraulic cylinders, they may require service or replacement during the registration period of an attached registration sticker. After repair or replacement, the motorcycle owner has to replace the registration sticker.

### SUMMARY

A registration sticker display apparatus may be formed of a resilient tube having a longitudinal slot to enable the tube to be removably clipped onto the front fork tube of a motorcycle. A registration sticker may be attached to the outer surface of the sticker display tube. The display tube may be removed prior to any service or replacement necessary for the front fork tube.

Alternatively, any suitable element of a motorcycle may be used to engage the sticker display such as a frame element or a seat support. The motorcycle element that secures the sticker display may also have a slightly conical shape or any other compound or complex shape and the sticker display may be shaped to correspond to the desired motorcycle element.

Where the state motor vehicle department requires permanent attachment of a vehicle registration, the sticker display apparatus may be permanently fastened to a motorcycle or other off highway vehicle using any suitable fasteners such as screws, pop-rivets or plastic rivets.

### BRIEF DESCRIPTION OF THE DRAWINGS

FIG. 1 is a perspective view of a registration sticker display apparatus.

FIG. 2 is an exploded view of a registration indicia, registration display apparatus and motorcycle front fork.

### DETAILED DESCRIPTION OF THE INVENTIONS

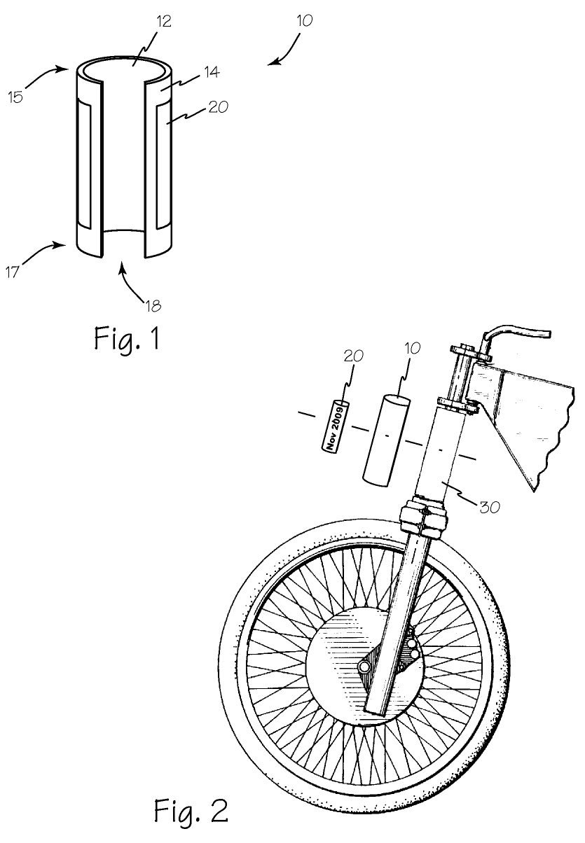

Registration display apparatus 10 of FIG. 1 is a cylinder formed of any suitable resilient material such as plastic or metal. Display apparatus 10 includes an inside surface 12, outside surface 14, first end 15, second end 17 and slot 18. Slot 18 enables display apparatus 10 to be removably fitted to any suitable, tubular element of a motorcycle without tools. Inside surface 12 may include adhesive or surface treatment to optimize frictional engagement of a tubular motorcycle element. Any suitable indicia such as registration sticker 20 may be attached to outside surface 14.

Referring now to FIG. 2, in use, vehicle registration sticker 20 may be secured to the outside surface of display apparatus 10 which may in turn be removable secured to motorcycle fork tube 30.

For most application, display apparatus 10 will be fitted on a circular cylinder such as motorcycle fork tube 30. Display apparatus 10 may be modified as necessary to securely fit other components of a motorcycle such as a frame element, seat bar or shock extension tube which may not be strictly a circular cylinder or a right circular cylinder.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A motorcycle registration display apparatus comprising:
a generally cylindrical display tube having a first end, a second end, an inner surface and an outer surface and formed of resilient material, the display tube including a generally longitudinal slot extending from the first end to the second end enabling the display tube to frictionally engage any compatible tubular structure on a motorcycle, the outer surface of the display tube adapted to securely engage a vehicle registration sticker.

2. The motorcycle registration display apparatus of claim 1 wherein the display tube has a slight conical taper.

3. The motorcycle registration display apparatus of claim 1 further comprising:
one or more fasteners for securing the registration display apparatus to any suitable element of a motorcycle.

4. The motorcycle registration display apparatus of claim 3 wherein the one or more fasteners comprise:
screws.

5. The motorcycle registration display apparatus of claim 1 further comprising:
adhesive on the inside surface for engaging a compatible tubular structure on a motorcycle.
